(19) United States
(12) Patent Application Publication
(10) Pub. No.: US 2024/0160814 A1
(43) Pub. Date: May 16, 2024

(54) GENERATE 3D MODELS OF TRANSFER MOLDS WITH COMPLIANCE LEVELS

(71) Applicant: Hewlett-Packard Development Company, L.P., Spring, TX (US)

(72) Inventor: John Joseph BRIDEN, Palo Alto, CA (US)

(21) Appl. No.: 18/284,126

(22) PCT Filed: Apr. 13, 2021
(86) PCT No.: PCT/US2021/027117

§ 371 Date: Sep. 26, 2023

(51) Int. Cl. G06F 30/27; B29C 51/36; G06F 119/18

(52) U.S. Cl. CPC G06F 30/27; B29C 51/36; G06F 2119/18

(57) ABSTRACT

According to examples, a non-transitory computer-readable medium may have stored thereon instructions that may cause a processor to determine a compliance level that the transfer mold is to have when the transfer mold is fabricated, in which the compliance level is to cause the transfer mold to apply a predefined level of force onto the wet part while reducing a risk of damage to the transfer mold caused by the application of the predefined level of force. The instructions may also cause the processor to generate a three-dimensional (3D) model of the transfer mold to have the determined compliance level when the transfer mold is fabricated.

### BACKGROUND

Various types of products may be fabricated from a pulp of material. Particularly, a pulp molding die that includes a forming mold and a screen may be immersed in the pulp of material and the material in the pulp may form into the shape of the forming mold and the screen. The forming mold and the screen may have a desired shape of the product to be formed. The forming mold and the screen may include numerous pores for liquid passage, in which the pores in the screen may be significantly smaller than the pores in the forming mold. During formation of the product, a vacuum force may be applied through the pulp molding die which may cause some of the material in the pulp to be suctioned onto the screen and form into a shape that matches the shape of the pulp molding die. The material may be removed from the screen and may be solidified, for example through drying, to have the desired shape.

### BRIEF DESCRIPTION OF THE DRAWINGS

Features of the present disclosure are illustrated by way of example and not limited in the following figure(s), in which like numerals indicate like elements, in which:

FIG. 1 shows a block diagram of an example computer-readable medium that may have stored thereon computer-readable instructions for determining a compliance level that a transfer mold is to have and for generating a 3D model of the transfer mold to have the determined compliance level when the transfer mold is fabricated;

FIG. 2 shows a diagram, which includes an example processor that may execute the computer-readable instructions stored on the example computer-readable medium to generate the 3D model of the transfer mold;

FIGS. 3A and 3B, respectively, depict cross-sectional side views of an example forming tool and an example transfer tool;

FIG. 3C shows a cross-sectional side view of the example forming tool and the example transfer tool depicted in FIGS. 3A and 3B during a removal operation by the example transfer tool of the wet part from the example forming tool;

FIG. 3D shows an enlarged cross-sectional view of a section of the example transfer tool shown in FIG. 3B; and

FIG. 4 shows a flow diagram of an example method for dewatering and transferring a wet part by a transfer tool having a compliant feature.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Disclosed herein are transfer molds for pulp molding tool sets that may perform dewatering and transfer operations on a wet part formed on a forming tool of the pulp molding tool sets. As discussed herein, the transfer molds may include a compliance level, e.g., a compressibility level, an elasticity level, or the like, that may enable the transfer molds to dewater the wet part while the wet part is on the forming tool and while reducing a risk of damage to the transfer molds.

Also discussed herein are computer-readable media that may have stored thereon instructions that may cause a processor to determine the compliance level that a transfer mold is to have based on input factors. The input factors may pertain to pressures that the transfer mold is predicted to undergo during use of the transfer mold to dewater the wet part and use of the transfer mold to transfer the wet part from the forming tool. Dewatering the wet part may include removing some of the water contained in the wet part. The processor may also generate a 3D model of the transfer mold to have the determined compliance level when the transfer mold is fabricated, for instance, by a 3D fabrication system.

Through implementation of various features of the present disclosure, a transfer tool may dewater wet parts while having a reduced risk of damage to the transfer tool. Dewatering of the wet parts through use of the transfer tool may be beneficial in that the drier wet parts may reduce energy, e.g., fuel, and time consumed by a dryer or oven to dry the wet parts. In addition, by using the transfer tool to dewater the wet parts as discussed herein, benefits associated with dewatering the wet parts may be achieved without requiring the use of a separate wet press.

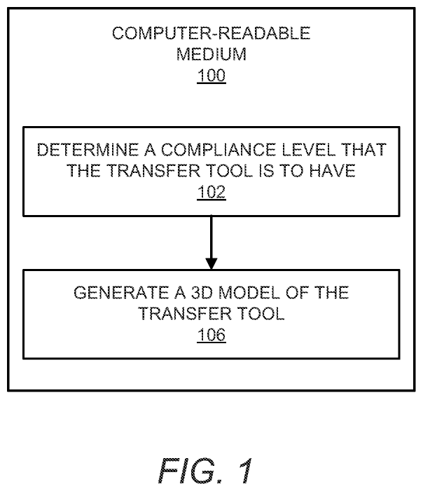

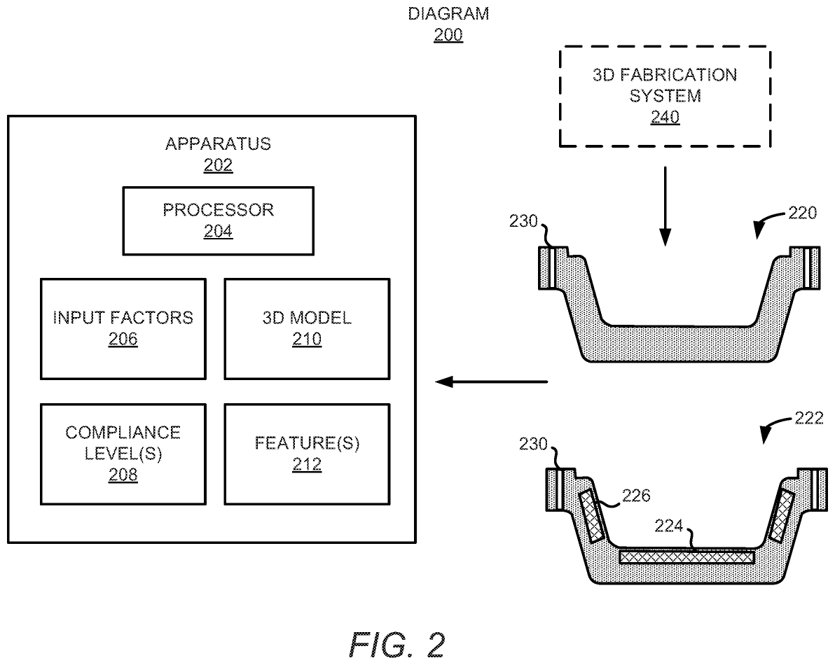

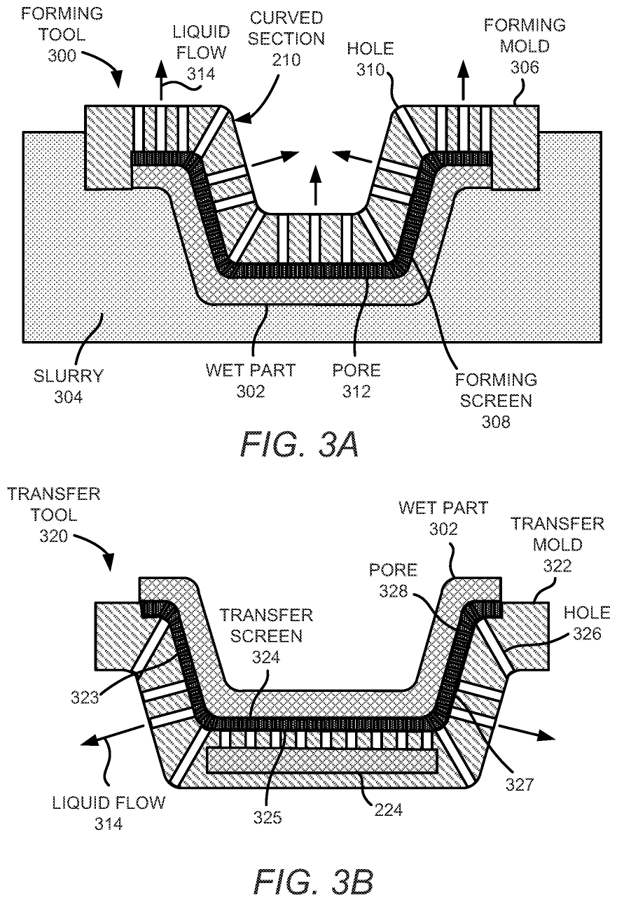

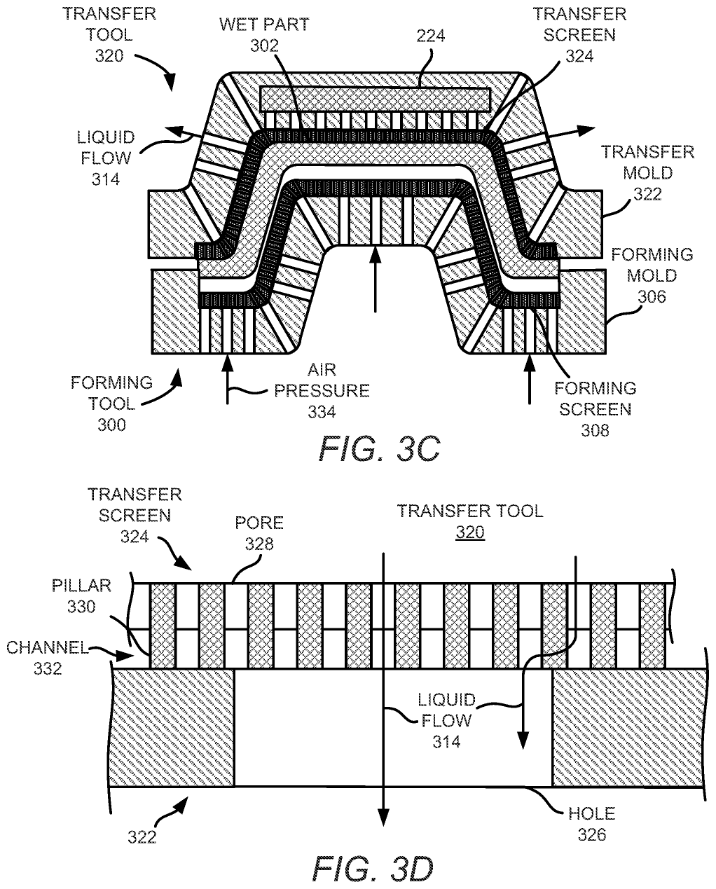

Reference is first made to FIGS. 1, 2, and 3A-3C. FIG. 1 shows a block diagram of an example computer-readable medium 100 that may have stored thereon computer-readable instructions for determining a compliance level that a transfer mold 322 is to have and for generating a 3D model 210 of the transfer mold 322 to have the determined compliance level when the transfer mold 322 is fabricated. FIG. 2 shows a diagram 200, which includes an example processor 204 that may execute the computer-readable instructions stored on the example computer-readable medium 100 to generate the 3D model 210 of the transfer mold 322. FIGS. 3A and 3B, respectively, depict, cross-sectional side views of an example forming tool 300 and an example transfer tool 320 and FIG. 3C shows a cross-sectional side view of the example forming tool 300 and the example transfer tool 320 during a removal by the example transfer tool 320 of the wet part 302 from the example forming tool 300.

It should be understood that the example computer-readable medium 100 depicted in FIG. 1, the example processor 204 depicted in FIG. 2, and/or the example forming tool 300 and the example transfer tool 320 respectively depicted in FIGS. 3A-3C may include additional attributes and that some of the attributes described herein may be removed and/or modified without departing from the scopes of the example computer-readable medium 100, the example processor 204, and/or the example forming tool 300 and the example transfer tool 320.

The computer-readable medium 100 may have stored thereon computer-readable instructions 102-106 that a processor, such as the processor 204 depicted in FIG. 2, may execute. The computer-readable medium 100 may be an electronic, magnetic, optical, or other physical storage device that contains or stores executable instructions. The computer-readable medium 100 may be, for example, Random Access memory (RAM), an Electrically Erasable Programmable Read-Only Memory (EEPROM), a storage device, an optical disc, and the like. Generally speaking, the computer-readable medium 100 may be a non-transitory computer-readable medium, in which the term “non-transitory” does not encompass transitory propagating signals.

The processor 204 may fetch, decode, and execute the instructions 102 to determine a compliance level 208 that a transfer mold 322 is to have when the transfer mold 322 is fabricated. As discussed herein, the compliance level is to cause the transfer mold 322 to apply a predefined level of force onto the wet part while reducing a risk of damage to the transfer mold caused by the application of the predefined level of force onto the wet part.

In some examples, the processor 204 may determine the compliance level that the transfer mold is to have based on input factors 206. In these examples, the processor 204 may obtain input factors 206 pertaining to pressures that a transfer mold 322 is predicted to undergo during use of the transfer mold 322 to dewater a wet part 302 while the wet part 302 is on a forming tool 300, and use of the transfer mold 322 to transfer the wet part 302 from the forming tool 300. As discussed in greater detail herein, the transfer mold 322 may be part of a transfer tool 320. In some examples, the transfer tool 320 may include a transfer screen 324 positioned on the transfer mold 322. In these examples, the transfer screen 324 may be in contact with the wet part 302 during performance of the dewatering and transfer operations. In other examples in which the transfer screen 324 is omitted, the transfer mold 322 may be in contact with the wet part 302 during performance of the dewatering and transfer operations.

The input factors 206 may include various types of factors that may affect the pressure that the transfer mold 322 may experience during use of the transfer mold 322. The input factors 206 may include a topography of the transfer mold 322, a topography of a surface of the wet part 302 that is to face the transfer mold 322, a type of material included in a slurry 304 from which the wet part 302 is to be molded, an amount of pressure that the transfer mold 322 is predicted to apply onto the wet part 302 during dewatering of the wet part 302 while the wet part 302 is on a forming tool 300, and/or the like.

In some examples, and as shown in FIG. 3B, the wet part 302 may include multiple surfaces and the transfer mold 322 may include multiple sections 323, 325, 327. The multiple sections 323, 325, 327 may include sections of the transfer mold 322 that are at different angles with respect to each other. In addition, or alternatively, the multiple sections may be sections that are along the same plane with respect to each other. By way of example, a first section of the transfer mold 322 may be a horizontally extending section and a second section of the transfer mold 322 may be a section that is angled with respect to the horizontally extending section.

As another example, a first section of the transfer mold 322 may be a first part of the horizontally extending section and a second section of the transfer mold 322 may be a second part of the horizontally extending section. In this example, the first section may undergo a different pressure than the second section due to, for instance, a topographical feature on a corresponding portion of the wet part 302. In some instances, for instance, due to the way in which the pulp fibers in the slurry 304 may group together on the forming tool 300, the wet part 302 may not have a uniform thickness. Instead, the surface of the wet part 302 that faces away from the forming tool 300 may include a portion that is relatively higher than other portions of the wet part 302. The relatively higher portion may be formed on each of the wet parts 302 that are formed on the forming tool 300 due to how the dynamics of the slurry 304 shapes the fiber mat as the liquid in the slurry 304 flows through the forming tool 300.

The processor 204 may fetch, decode, and execute the instructions 104 to determine, based on the obtained input factors 206, a compliance level 208 that the transfer mold 322 is to have when the transfer mold 322 is fabricated. The compliance level 208 may be determined to be a level that may cause the transfer mold 322 to apply a predefined level of force onto the wet part 302 while reducing a risk of damage to the transfer mold 322 caused by the application of the predefined level of force. The compliance level 208 may equivalently be termed the compression level because the compliance level 208 may be directed to the amount of compression that the transfer mold 322 is to undergo when the transfer mold 322 is used to apply sufficient force to dewater the wet part 302 while the wet part 302 is on the forming tool 300. The processor 204 may determine the predefined level of force and the compliance level 208 through testing, modeling, simulations, and/or the like. By way of example, the processor 204 may implement machine-learning techniques on the input factors 206 to determine the compliance level.

By having the compliance level 208, the transfer mold 322 may apply sufficient force onto the wet part 302 to force some water out of the wet part 302 while the wet part 302 is on the forming tool 300 and while being protected from damage when the transfer mold 322 applies force onto the wet part 302. That is, the transfer mold 322 may apply the sufficient force even in instances in which the wet part 302 includes a portion that is relatively higher than other portions of the wet part 302. In other words, if the transfer mold 322 were rigid, the relatively higher portion of the wet part 302 may cause uneven pressure to be applied onto the transfer mold 322, which may cause the transfer mold 322 to become damaged over repeated usage.

As discussed herein, the wet part 302 may have multiple surfaces and multiple sections of the transfer mold 322 may undergo various pressures. In these examples, the processor 204 may determine multiple compliance levels 208 that the transfer mold 322 is to have when the transfer mold 322 is fabricated based on the input factors 206.

The processor 204 may fetch, decode, and execute the instructions 106 to generate a three-dimensional (3D) model 210 of the transfer mold 322 to have the determined compliance level 208 when the transfer mold 322 is fabricated. The processor 204 may generate the 3D model 210 as a computer aided design (CAD) file, or other digital representation of these components. For instance, the processor 204 may generate the 3D model 210 as a 3D manufacturing format (3MF) file, an STL file, and/or the like. In some examples, the processor 204 may generate the 3D model 210 by modifying a previously obtained copy of the 3D model 210 of the transfer mold 322 and to add a feature to the 3D model 210 to cause the transfer mold 322 to have the determined compliance level 208 or the multiple determined compliance levels 208.

According to examples, prior to generating the 3D model 210, the processor 204 may determine features 212 to be included in the transfer mold 322 for the transfer mold 322 to have the determined compliance level. The processor 204 may determine the features 212 to be included based on historical data, testing, modeling, simulations, and/or the like. The features 212 may include a type of physical structure to be formed in the transfer mold 322, a type of material to be used to fabricate the transfer mold 322, and/or the like. The processor 204 may also generate the 3D model 210 to include the features 212.

An example in which the feature 212 is a type of material to be used to fabricate the transfer mold 322 is shown as transfer mold 220 in FIG. 2. In this example, the material may be a compliant material, such as a polymer material, or the like. In addition, the same material or multiple types of materials having different compressive properties may be used to correspond to multiple compliance levels 208. In instances in which the same material is used, the material may be applied at various densities and/or shapes to correspond to the multiple compliance levels.

An example in which the feature 212 is a type of physical structure is depicted in FIG. 2 as transfer mold 222. In this example, the features 212 may be areas of lower density, areas of higher compressibility, and/or the like. By way of example, the features 212 may be compressible lattice structures 224, 226 that may be designed to have the compliance levels 208. For instance, the lattice structure 224 may have a different compliance level 208 than the lattice structures 226 for reasons as discussed herein. In other examples, the features may have other types of compressible structures, such as a mesh structure, a foam-like structure, and/or the like. In any of these examples, the transfer mold 222 may be formed of a compliant material similar to the transfer mold 220 or may be formed of a non-compliant material, such as a material used by 3D fabrication systems to fabricate parts.

As also shown in FIG. 2, the example transfer molds 220, 222 may include holes 230 through which air and/or liquid may flow. As discussed herein, air may flow through the holes 230 to apply suction forces onto the wet part 302 during removal of the wet part 302 from the forming tool 300. In some examples, the processor 204 may determine locations at which the holes 230 are to be included in the transfer mold 322. In these examples, the processor 204 may generate the 3D model 210 to include the holes 230 at the determined locations.

In some examples, and as shown in FIG. 3B, the transfer mold 322 may include a larger number of holes 326 than as shown FIG. 2. In these examples, suction pressure may be applied across a greater surface area of the wet part 302 by the transfer mold 322 than in the transfer molds 220, 222. In FIG. 3B, the holes 326 that are above the physical structure feature 224 may be connected to other holes 326 that may extend to the other side of the transfer mold 322 such that liquid may flow through the holes 326. In addition, or alternatively, the holes 326 may extend through the structural feature 224, e.g., the holes 326 may be formed inside the structural feature 224. Although the transfer mold 322 has been depicted as including the feature 224, it should be understood that the transfer mold 322 may instead or additionally include the type of material feature 212 as shown in the transfer mold 220 in FIG. 2.

As also shown in FIG. 3B, a transfer screen 324 may be provided on the transfer mold 322 such that the transfer screen 324 is positioned between the transfer mold 322 and the wet part 302. The transfer screen 324 may include a plurality of pores 328, which are smaller than the holes 326 in the transfer mold 322. The processor 204 may also generate a 3D model of the transfer screen 324 in any of the manners discussed above with respect to the generation of the 3D model 210 of the transfer mold 322. The transfer screen 324 may be formed of a compliant material and/or may be formed to have a sufficiently small thickness to enable the transfer screen 324 to be as or more compliant than the transfer mold 322.

The processor 204 may cause a 3D fabrication system 240 to fabricate the transfer mold 322 based on the 3D model 210. The processor 204 may also cause the 3D fabrication system 240 to fabricate the transfer screen 324. For instance, the processor 204 may send the 3D model 210 (and/or, in some examples, a 3D model of the transfer screen 324) to the 3D fabrication system 240. In these examples, a controller or processor of the 3D fabrication system 240 may process or otherwise use the 3D model 210 to fabricate the transfer screen 324. In other examples, the processor 204 may be the controller or processor of the 3D fabrication system 240 and may thus process (e.g., voxelize, slice, etc.) or otherwise use the 3D model 210 to fabricate the transfer screen 324 to have the determined compliance level.

In some examples, the processor 204 may be part of an apparatus 202, which may be a computing system such as a server, a laptop computer, a tablet computer, a desktop computer, or the like. The processor 204 may be a semiconductor-based microprocessor, a central processing unit (CPU), an application specific integrated circuit (ASIC), a field-programmable gate array (FPGA), and/or other suitable hardware device. The apparatus 202 may also include a memory that may have stored thereon computer-readable instructions (which may also be termed computer-readable instructions) that the processor 204 may execute. The memory may be an electronic, magnetic, optical, or other physical storage device that contains or stores executable instructions. The memory may be, for example, Random Access memory (RAM), an Electrically Erasable Programmable Read-Only Memory (EEPROM), a storage device, an optical disc, and the like. The memory, which may also be referred to as a computer-readable storage medium, may be a non-transitory computer-readable storage medium, where the term “non-transitory” does not encompass transitory propagating signals.

The 3D fabrication system 240 may be any suitable type of additive manufacturing system. Examples of suitable additive manufacturing systems may include systems that may employ curable binder jetting onto build materials (e.g., thermally or UV curable binders), print agent jetting onto build materials (e.g., fusing agents, detailing agents, etc.), selective laser sintering, stereolithography, fused deposition modeling, etc. In a particular example, the 3D fabrication system 240 may form the transfer mold 322 by binding and/or fusing build material particles together. In any of these examples, the build material particles may be any suitable type of material that may be employed in 3D fabrication processes, such as, a metal, a plastic, a nylon, a ceramic, a polymeric material, an alloy, and/or the like.

Particular reference is now made to FIGS. 3A-3C. FIG. 3A shows a cross-sectional side view of the forming tool 300, in which a portion of the forming tool 300 has been depicted as being placed within a volume of a slurry 304 of a liquid and material elements. In some examples, the liquid may be water or another type of suitable liquid in which pulp material, e.g., paper, wood, fiber crops, bamboo, or the like, may be mixed into the slurry 304. The material elements may be, for instance, fibers of the pulp material. FIG. 3B shows a cross-sectional side view of the transfer tool 320 and FIG. 3C shows a cross-sectional side view of the forming tool 300 and the transfer tool 320 during a dewatering and transfer process by the transfer tool 320 of the wet part 302 from the forming tool 300. The forming tool 300 and the transfer tool 320 may collectively form a pulp molding tool set.

As shown in FIG. 3A, the forming tool 300 may include a forming mold 306 and a forming screen 308, in which the forming screen 308 may overlay the forming mold 306. As shown in FIG. 3B, the transfer tool 320 may include a transfer mold 322 and a transfer screen 324. In some examples, the forming screen 308 and the transfer screen 324 may be fabricated by a 3D fabrication system 240. The 3D fabrication system 240 may also fabricate the forming mold 306 and the transfer screen 324.

In some examples, the forming mold 306 and/or the transfer mold 322 may be removably mounted onto respective supporting structures (not shown) such that, for instance, the forming mold 306 may be moved independently from the transfer mold 322. Moreover, the forming mold 306 and the forming screen 308 may be fabricated to have shapes to which the wet part 302 may be molded when formed on the forming screen 308. Likewise, the transfer mold 322 and the transfer screen 324 may be fabricated to have shapes that may engage multiple surfaces of the wet part 302 formed on the forming screen 308. The transfer screen 324 may have a shape that is complementary to, e.g., a shape that matches, the shape of the forming screen 308.

As shown, the forming mold 306 may be formed to have a relatively larger thickness than the forming screen 308 and the transfer mold 322 may be formed to have a relatively larger thickness than the transfer screen 324. In some examples, the transfer screen 324 and the forming screen 308 may have the same or similar thicknesses and/or the transfer mold 322 and the forming mold 306 may have the same or similar thicknesses. The larger thicknesses of the forming mold 306 and the transfer mold 322 may cause the forming mold 306 and the transfer mold 322 to be substantially more rigid than the forming screen 308 and the transfer screen 324. The forming mold 306 may provide structural support for the forming screen 308 and the transfer mold 322 may provide structural support for the transfer screen 324.

The forming mold 306 and/or the forming screen 308 may include an attachment mechanism (or attachment device) for the forming screen 308 to be mounted to the forming mold 306. Likewise, the transfer mold 322 and/or the transfer screen 324 may include an attachment mechanism (or attachment device) for the transfer screen 324 to be mounted to the transfer mold 322. In either case, the mechanism may include mechanical fasteners, detents, and/or the like to enable the forming screen 308 to be removably mounted onto the forming mold 306 and/or the transfer screen 324 to be removably mounted onto the transfer mold 322. The mechanism that mounts the forming screen 308 to the forming mold 306 and/or that mounts the transfer screen 324 to the transfer mold 322 may be a quick release mechanism to enable the forming screen 308 and/or the transfer screen 324 to easily be released from the respective forming mold 306 and transfer mold 322. This may facilitate replacement of the forming screen 308 and/or the transfer screen 324 for maintenance purposes and/or for screens 308, 324 having different features to be employed in the formation of wet parts 302.

As also shown in FIGS. 3A-3C, the forming mold 306 and the transfer mold 322 may respectively include holes 310, 326 and the forming screen 308 and the transfer screen 324 may respectively include pores 312, 328 that may extend completely through respective top and bottom surfaces of the forming mold 306, the forming screen 308, the transfer mold 322, and the transfer screen 324. The pores 312, 328 may be significantly smaller than the holes 310, 326. In addition, a plurality of structural features, such as pillars 330 (shown in FIG. 3D) may be provided between the surfaces of the forming mold 306 and the forming screen 308 and between the transfer mold 322 and the transfer screen 324 that are respectively adjacent and face each other to enable liquid to flow laterally between the forming mold 306 and the forming screen 308 and between the transfer mold 322 and the transfer screen 324 as denoted by the arrow 314. As some of the pores 312 in the forming screen 308 may not directly align with the pores 312 in the forming mold 306 and some of the pores 328 in the transfer screen 324 may not directly align with the pores 328 in the transfer mold 322, the channels 332 formed by the structural features may enable liquid to flow through those pores 312, 328 in addition to the pores 312, 328 that are directly aligned with respective the holes 310, 326.

Although not shown, the forming tool 300 may be in communication with a plenum to which a vacuum source may be connected such that the vacuum source may apply a vacuum pressure through the holes 310 and the pores 312 in the forming mold 306 and the forming screen 308. When the vacuum pressure is applied through the holes 310 and the pores 312, some of the liquid in the slurry 304 may be suctioned through the holes 310 and the pores 312 and may flow into the plenum as denoted by the arrows 314. As the liquid flows through the holes 310 and the pores 312, the forming screen 308 may prevent the material elements in the slurry 304 from flowing through the pores 312. That is, the pores 312 may have sufficiently small dimensions, e.g., diameters or widths, that may enable the liquid to flow through the pores 312 while blocking the material elements from flowing through the pores 312. In one regard, the diameters or widths of the pores 312 may be sized based on sizes of the material elements, e.g., fibers, in the slurry 304. By way of particular example, the pores 312 may have diameters of around 0.6 mm. The pores 328 in the transfer screen 324 may also have similar diameters. However, in some instances, the pores 328 (as well as the pores 312) may have irregular shapes as may occur during 3D fabrication processes.

Over a period of time, which may be a relatively short period of time, e.g., about a few seconds, less than about a minute, less than about five minutes, or the like, the material elements may build up on the forming screen 308. Particularly, the material elements in the slurry 304 may be accumulated and compressed onto the forming screen 308 into the wet part 302. The wet part 302 may take the shape of the forming screen 308. In addition, the thickness and density of the wet part 302 may be affected by the types and/or sizes of the material elements in the slurry 304, the length of time that the vacuum pressure is applied while the forming mold 306 and the forming screen 308 are placed within the volume of the slurry 304, etc. That is, for instance, the longer that the vacuum pressure is applied while the forming mold 306 and the forming screen 308 are partially immersed in the slurry 304, the wet part 302 may be formed to have a greater thickness.

After a predefined period of time, e.g., after the wet part 302 having desired properties has been formed on the forming screen 308, the forming mold 306 and the forming screen 308 may be removed from the volume of slurry 304. For instance, the forming mold 306 may be mounted to a movable mechanism that may move away from the volume of slurry 304. In some examples, the movable mechanism may rotate with respect to the volume such that rotation of the movable mechanism may cause the forming mold 306 and the forming screen 308 to be removed from the volume of slurry 304. In other examples, the movable mechanism may be moved laterally with respect to the volume of slurry 304. As the forming mold 306 and the forming screen 308 are removed from the volume, some of the excess slurry 304 may come off of the wet part 302. However, the wet part 302 may have a relatively high concentration of liquid.

Following the formation of the wet part 302 on the forming screen 308 and movement of the forming screen 308 and the wet part 302 out of the volume of slurry 304, the transfer tool 320 may be moved such that the transfer screen 324 may contact the wet part 302 on the forming screen 308. That is, for instance, the transfer mold 322 may be attached to a movable mechanism (not shown), in which the movable mechanism may cause the transfer mold 306 and the transfer screen 324 to move toward the forming screen 308. In some examples, the transfer tool 320 may be moved to cause the transfer screen 324 to be in contact with the wet part 302 and to cause the transfer tool 320 to apply pressure onto the wet part 302 to dewater the wet part 302 while the wet part 302 is on the forming screen 308, e.g., within a second or within a few seconds of the wet part 302 being removed from the volume of slurry 304. The transfer tool 320 may continue to apply pressure onto the wet part 302 for a predefined length of time, e.g., an amount of time that may result in a certain, e.g., maximum, amount of liquid being removed from the wet part 302. In some examples, the liquid that is removed from the wet part 302 during this dewatering process may be suctioned through the pores 312 and the holes 310 in forming tool 300.

In addition, the transfer tool 320 may be in communication with a plenum to which a vacuum source may connected such that the vacuum source may apply a vacuum pressure through the holes 326 and the pores 328 while the wet part 302 is in contact with the transfer screen 324. The vacuum source may be the same or a different vacuum source to which the forming tool 300 may be in communication. Following the predefined length of time, the vacuum pressure applied through the forming tool 300 may be terminated or reversed (e.g., applied in the opposite direction) while vacuum pressure may be applied through the transfer tool 320 to facilitate transfer of the wet part 302 from the forming tool 300 to the transfer tool 320.

FIG. 3C shows a state in which the transfer tool 320 may be in the process of removing the wet part 302 from the forming screen 308. Particularly, in that figure, the transfer screen 324 has been moved into contact with the wet part 302 and a vacuum pressure has been applied onto the wet part 302 through the transfer screen 324. In addition, while the vacuum pressure is applied onto the wet part 302, the transfer tool 320 may be moved away from the forming tool 300 (or the forming tool 300 may be moved away from the transfer tool 320) to pull the wet part 302 off of the forming screen 308. To further facilitate removal of the wet part 302 from the forming screen 308, air pressure may be applied through the forming tool 300 as denoted by the arrows 334. As such, the wet part 302 may be biased toward the transfer tool 320 as opposed to being biased toward the forming tool 300. While the wet part 302 is biased toward the transfer tool 320, the transfer tool 320 may be moved away from the forming tool 300 such that the transfer tool 320 may remove the wet part 302 from the forming tool 300. In FIG. 3C, the forming tool 300 and the transfer tool 320 have been rotated 180° from their respective positions in FIGS. 3A and 3B. It should, however, be understood that the transfer mold 322 may remove the wet part 302 from the forming screen 308 while the forming tool 300 and the transfer tool 320 are in other orientations.

As shown in FIG. 3B, the transfer screen 324 may include pores 328 across multiple surfaces of the transfer screen 324. In some examples, the pores 328 may be positioned deterministically in the transfer screen 324 to cause pressure to be applied substantially evenly across the transfer screen 324 when the vacuum pressure is applied. As a result, pressure may be applied substantially evenly across the surface of the wet part 302 that is in contact with the transfer screen 324. This may prevent the application of increased pressure at a particular location on the surface of the wet part 302, which may prevent the wet part 302 from being damaged by the application of the pressure onto the wet part 302 through the transfer screen 324. Additionally, this may enable the transfer tool 320 to remove wet parts 302 having a vertically or substantially vertically extending (e.g., zero draft) surface (or surfaces) from the forming screen 308 as the pressure may be sufficient to overcome frictional and other forces applied by the forming screen 308 onto the wet part 302.

When the wet part 302 is in contact with the transfer screen 324, the wet part 302 may include some of the liquid from the slurry 304. In addition, when the vacuum pressure is applied through the holes 326 and the pores 328, some of the liquid in the wet part 302 may be suctioned through the holes 326 and the pores 328 and may flow into the plenum as denoted by the arrows 314. In one regard, the application of the vacuum pressure through the holes 326 and the pores 328 may further dewater the wet part 302 by removing some of the liquid through an upper surface of the wet part 302. As a result, of the dewatering operations performed during the transfer of the wet part 302 from the forming tool 300 to the transfer tool 320, when the wet part 302 undergoes drying, for instance, in an oven, the amount of energy and/or the amount of time to dry the wet part 302 may significantly be reduced. The energy and/or time consumed to dry the wet part 302 may also be significantly reduced without using a separate wet press.

In another regard, the application of vacuum pressure through the holes 326 and the pores 328 may cause the material elements at the surface of the wet part 302 that is contact with the transfer screen 324 to have a greater density than the material elements closer to the center of the wet part 302. As a result, the wet part 302 may resist warpage during drying of the wet part 302, for instance, in an oven, due to a greater level of symmetrical shrinkage afforded by the denser surface matching the similarly dense surface on the forming screen 308 side of the wet part 302. Additionally, the surface may be relatively smoother than when the wet part 302 is allowed to dewater without the application of pressure onto the surface of the wet part 302.

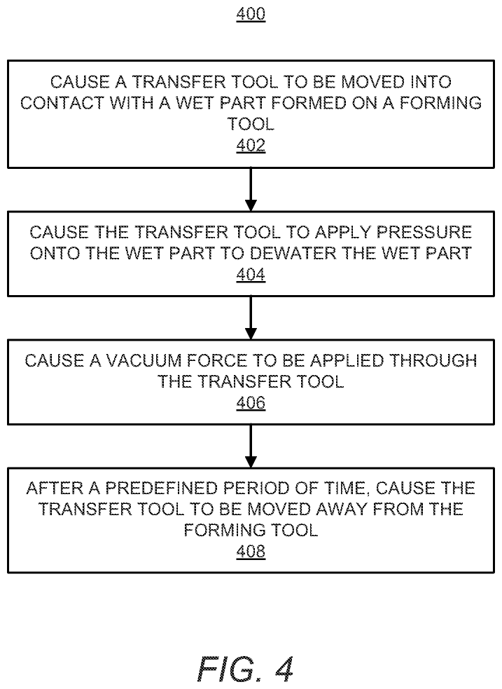

Turning now to FIG. 4, there is shown a flow diagram of an example method 400 for dewatering and transferring a wet part 302 by a transfer tool having a compliant feature 212. It should be understood that the method 400 depicted in FIG. 4 may include additional operations and that some of the operations described therein may be removed and/or modified without departing from the scope of the method 400. The description of the method 400 is also made with reference to the features depicted in FIGS. 1-3D for purposes of illustration. In some examples, the processor 204 depicted in FIG. 2 may execute some or all of the operations included in the method 400 using the elements depicted in FIGS. 2-3D. In other examples, a processor or controller of a fiber mold fabrication machine may cause the operations included in the method 400 to be executed.

At block 402, a transfer tool 320 may be caused to be moved into contact with a wet part 302 formed on a forming tool 300. At block 404, the transfer tool may be caused to apply pressure onto the wet part 302 to dewater the wet part 302 while the wet part 302 is on the forming tool 300. As discussed herein, the transfer tool 320, and particularly, the transfer mold 322 of the transfer tool 320, may include a compliant feature 212 that may enable a predefined level of force to be applied onto the wet part 302 while reducing a risk of damage to the transfer tool 320 caused by the application of the predefined level of force onto the wet part 302.

At block 406, a vacuum force may be caused to be applied through holes 326 in the transfer tool 320 onto the wet part 302. The application of the vacuum force may further dewater the wet part 302 and may cause the surface that is contact with the transfer tool 320 to become smoother. In addition, at block 408, after a predefined period of time, the transfer tool 320 may be caused to be moved away from the forming tool 300. The wet part 302 may remain in contact with the transfer tool 320 as the transfer tool 320 is moved away from the forming tool 300. The transfer tool 320 may also be caused to move the wet part 302 to a conveyer belt and/or an oven such that the wet part 302 may be dried further.

As discussed herein, the forming tool 300 may be caused to be positioned in a slurry 304 and a vacuum force may be caused to be applied through holes 310 and pores 312 in the forming tool 300 to cause the wet part 302 to be formed on the forming tool 300 from a pulp in the slurry 304. The vacuum force may be caused to be continued to be applied through the holes 310 and the pores 312 in the forming tool while the transfer tool 3210 applies pressure onto the wet part 302 to suction water that has been expelled from the wet part 302. In addition, a blowing force may be caused to be applied through the holes and the pores in the forming tool 300 after the predefined period of time.

Some or all of the operations set forth in the method 400 may be contained as utilities, programs, or subprograms, in any desired computer accessible medium. In addition, the method 400 may be embodied by computer programs, which may exist in a variety of forms. For example, the method 400 may exist as computer-readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration and are not meant as limitations. Many variations are possible within the scope of the disclosure, which is intended to be defined by the following claims—and their equivalents—in which all terms are meant in their broadest reasonable sense unless otherwise indicated.

What is claimed is:

1. A non-transitory computer-readable medium on which is stored machine-readable instructions that when executed by a processor, cause the processor to:
determine a compliance level that a transfer mold is to have when the transfer mold is fabricated, wherein the compliance level is to cause the transfer mold to apply a predefined level of force onto a wet part while reducing a risk of damage to the transfer mold caused by the application of the predefined level of force onto the wet part; and
generate a three-dimensional (3D) model of the transfer mold to have the determined compliance level when the transfer mold is fabricated.

2. The non-transitory computer-readable medium of claim 1, wherein the instructions cause the processor to:
obtain input factors pertaining to pressures that a transfer mold is predicted to undergo during:
use of the transfer mold to dewater the wet part while the wet part is on a forming tool; and
use of the transfer mold to transfer the wet part from the forming tool; and
determine the compliance level that the transfer mold is to have based on the obtained input factors.

3. The non-transitory computer-readable medium of claim 2, wherein the input factors comprise a topography of the transfer mold, a topography of a surface of the wet part that is to face the transfer mold, a type of material included in a slurry from which the wet part is to be molded, and/or an amount of pressure that the transfer mold is predicted to apply onto the wet part during dewatering of the wet part while the wet part is on a forming tool.

4. The non-transitory computer-readable medium of claim 2, wherein the wet part is to have multiple surfaces and wherein multiple sections of the transfer mold are to undergo various pressures, and wherein the instructions are further to cause the processor to:
determine multiple compliance levels that the transfer mold is to have when the transfer mold is fabricated based on the input factors; and
generate the 3D model to include the multiple compliance levels at respective locations of the 3D model.

5. The non-transitory computer-readable medium of claim 1, wherein the instructions are to cause the processor to:
determine features to be included in the transfer mold for the transfer mold to have the determined compliance level, wherein the features comprise a type of physical structure to be formed in the transfer mold and/or a type of material to be used to fabricate the transfer mold; and
generate the 3D model to include the determined features.

6. The non-transitory computer-readable medium of claim 1, wherein the instructions further cause the processor to:
determine locations at which a plurality of holes are to be included in the transfer mold through which air is to flow while maintaining the determined compliance level in the transfer mold; and
generate the 3D model of the transfer mold to include the plurality of holes at the determined locations.

7. The non-transitory computer-readable medium of claim 6, wherein the instructions further cause the processor to:
generate a 3D model of a transfer screen that is to be placed on the transfer mold, wherein the transfer screen includes a plurality of pores, wherein each of the plurality of pores is smaller than each of the plurality of holes, and wherein the transfer screen is to be placed between the transfer mold and the wet part during dewatering and transfer of the wet part.

8. The non-transitory computer-readable medium of claim 1, wherein the instructions further cause the processor to:
cause a three-dimensional (3D) fabrication system to fabricate the transfer mold based on the generated 3D model of the transfer mold.

9. A transfer tool comprising:
a transfer mold to engage a wet part formed from a pulp slurry in a forming tool, and while engaged with the wet part, the transfer mold is to apply a predefined level of force onto the wet part to dewater the wet part while reducing a risk of damage to the transfer mold caused by the application of the predefined level of force, wherein the transfer mold includes a plurality of holes through which air is flow, and wherein the transfer mold is:
formed of a compliant material that is to cause the transfer mold to apply the predefined level of force onto the wet part; and/or
includes a compliant structural feature that is to cause the transfer mold to apply the predefined level of force onto the wet part.

10. The transfer tool of claim 9, wherein the transfer mold comprises a first surface and a second surface and wherein the transfer mold further comprises:
a first section in line with the first surface having a first compliance level; and
a second section in line with the second surface having a second compliance level that differs from the first compliance level.

11. The transfer tool of claim 10, wherein the first compliance level and the second compliance level are to compensate for a variation in heights between a first area of the wet part that is to be in line with the first surface and a second area of the wet part that is to be in line with the second working surface when the transfer tool is engaged with the wet part.

12. The transfer tool of claim 9, wherein the transfer mold is formed of a compliant structural feature and wherein the compliant structural feature comprises a lattice structure.

13. The transfer tool of claim 9, further comprising:
a transfer screen comprising a plurality of pores, wherein the transfer screen is to be positioned between the transfer mold and the wet part when the transfer tool is engaged with the wet part.

14. A method comprising:
causing a transfer tool to be moved into contact with a wet part formed on a forming tool;
causing the transfer tool to apply pressure onto the wet part to dewater the wet part while the wet part is on the forming tool, wherein the transfer tool comprises a compliant feature that is to enable a predefined level of force to be applied onto the wet part while reducing a risk of damage to the transfer tool caused by the application of the predefined level of force;
causing a vacuum force to be applied through holes in the transfer tool onto the wet part; and
after a predefined period of time, causing the transfer tool to be moved away from the forming tool, wherein the wet part is to remain in contact with the transfer tool as the transfer tool is moved away from the forming tool.

15. The method of claim 14, further comprising:
causing the forming tool to be positioned in a slurry;
causing a vacuum force to be applied through holes in the forming tool to cause the wet part to be formed on the forming tool from a pulp in the slurry;
causing the vacuum force to be continued to be applied through the holes in the forming tool while the transfer tool applies pressure onto the wet part to suction water that has been expelled from the wet part; and
causing a blowing force to be applied through the holes in the forming tool after the predefined period of time.
